(19) United States
(12) Patent Application Publication
(10) Pub. No.: US 2013/0151936 A1
(43) Pub. Date: Jun. 13, 2013

(54) PAGE PREVIEW USING CONTEXTUAL TEMPLATE METADATA AND LABELING

(71) Applicants: Diana Hsu, Mountain View, CA (US); Keith A. Regier, Kirkland, WA (US); Khaled Rashad, Richmond (CA); Daniel Marantz, Bellevue, WA (US); Krishnan Thazhathekalam, Mountain House, CA (US); David D. Ahn, San Francisco, CA (US)

(72) Inventors: Diana Hsu, Mountain View, CA (US); Keith A. Regier, Kirkland, WA (US); Khaled Rashad, Richmond (CA); Daniel Marantz, Bellevue, WA (US); Krishnan Thazhathekalam, Mountain House, CA (US); David D. Ahn, San Francisco, CA (US)

(73) Assignee: Microsoft Corporation, Redmond, WA (US)

(21) Appl. No.: 13/316,568

(22) Filed: Dec. 12, 2011

(51) Int. Cl. G06F 17/30; G06F 17/00

(52) U.S. Cl. 715/205; 707/737; 715/243; 715/234; 707/E17.046

(57) ABSTRACT

Architecture that provides a preview template of information supplemented to a result entry of a results page, such as a search engine results page. A data component supplements the result entry with information from a results destination document. The information is segmented and grouped into logical collections of related results according to contextual templates. Each template is associated with an interactive label that exposes a corresponding collection in response to label interaction. Each label of a template is a visual cue that includes a descriptive title which relates to individual web results of the collection. A user can scan through the labels and interact only with the section (collection) of interest to obtain a preview of destination document results before committing a click that navigates the user to the destination document of the website. The labels are also ranked within the template of information for a given result entry.

### BACKGROUND

On existing search engines, a web result only shows one preview that contains either additional text or an image preview of the site. Additionally, only one preview is allowed per web result. Some web results may have useful content while other results may simply be repeated information or a useless image, thereby after repeated use, conveying to the user that there is a likelihood of data inconsistency inside the preview. Thus, the user experience teaches a lack of confidence in using the preview and the data itself. Moreover, the visual and interaction area is too small to be discovered by users. Thus, even though more information is provided inside the document preview on hover, users seldom engage the preview because the information is not readily visually discoverable. The default action of the user is then to only scan the web result title and snippet of a search result to assist in selecting the results that best match their needs.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a preview template of information supplemented to a result entry of a results page, such as a search engine results page. A data component supplements the result entry with information from a results destination document. The information is segmented and grouped into logical collections of related results according to contextual templates. Each template is associated with an interactive label that exposes a corresponding collection in response to label interaction.

Each label of a template is a visual cue that includes a descriptive title which relates to individual web results of the collection. A user can scan through the labels and interact only with the section (collection) of interest to obtain a preview of destination document results before committing a click that navigates the user to the destination document of the website. The labels are also ranked within the template of information for a given result entry.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a more detailed description of the data component.

FIG. 3 illustrates a results page having exemplary result entry template.

FIG. 4 illustrates a results page having an exemplary ingredients type of template.

FIG. 5 illustrates a results page having an exemplary hotel reservation type of template.

FIG. 6 illustrates a method in accordance with the disclosed architecture.

FIG. 7 illustrates further aspects of the method of FIG. 6.

FIG. 8 illustrates an alternative method in accordance with the disclosed architecture.

FIG. 9 illustrates further aspects of the method of FIG. 8.

FIG. 10 illustrates a block diagram of a computing system that executes segmentation, collection, and previewing in accordance with the disclosed architecture.

### DETAILED DESCRIPTION

The disclosed architecture supplements results of a results page with a hidden preview that is visually and readily accessible. A descriptive and contextual label is exposed that is visually noticeable to users. The label is part of a template, and the template segments the returned data into logical collections.

The templates are contextual with segmented data grouped logically and ranked, along with the labels. The data of a given webpage (website) is extracted using an extraction technique. The data is strongly typed and grouped based on its contextual relationship. For example, an individual review score is grouped with an author name of the author who provided the review, a review snippet, upload date of the review, content actor image, with birth date and biography, as one possible example.

Templates are provided that can be based on scenario and task importance. A restaurants-related website can return direction information, which can be deemed more important than review information and reservation information. Accordingly, these are ranked as such in the template. A template can be task oriented such as for a hotel reservation, where user input is received and submitted by way of the preview to the destination page by a dynamically-created URL (uniform resource locator), or other similar routing object.

The descriptive labels (annotation for a label) for each preview provide visual cues and context for each corresponding template. The label annotation (description) is tailored for each template (e.g., a Reviews label for a review snippet, a Biography label for an actor's background information, etc.). Data determined to be important can be presented in the label such as to display an aggregated Review score for review snippet, an average rate for a hotel reservation, etc. Moreover, the space available of a given result entry can be computed to determine the number of labels that can be presented. The number of labels is determined based on the number of lines the result entry (e.g., web caption) occupies.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

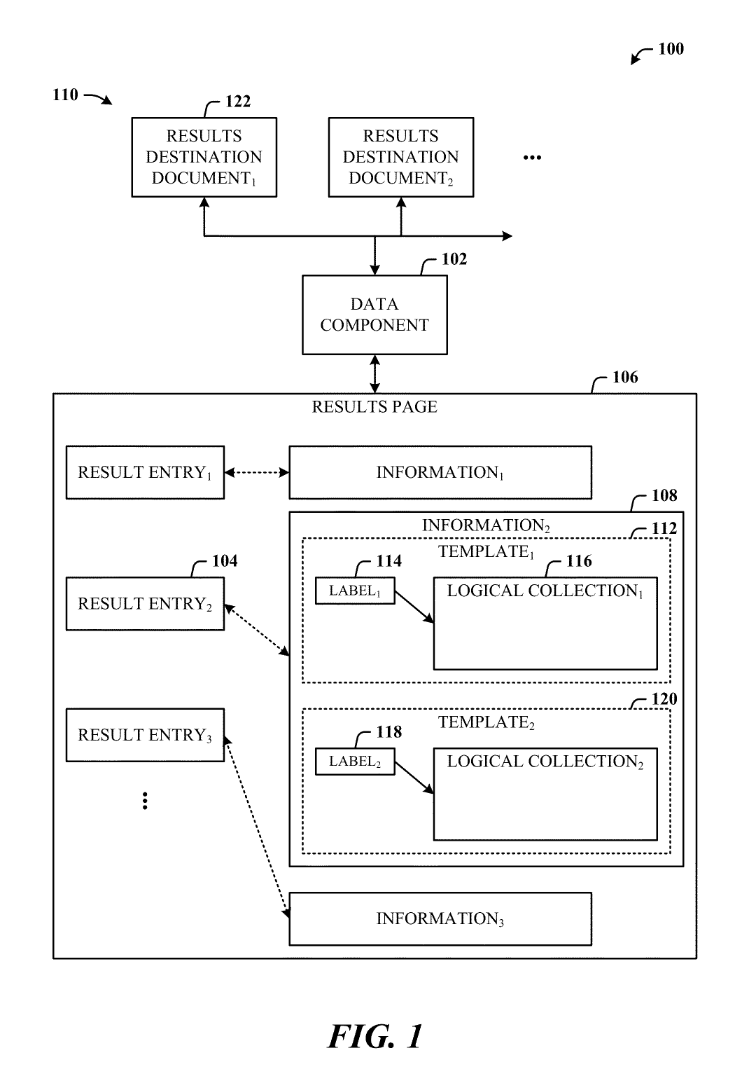

FIG. 1 illustrates a system 100 in accordance with the disclosed architecture. The system 100 comprises a data component 102 that supplements a result entry 104 (e.g., a search result, an answer to a question, etc.) of a results page 106 with information 108 from one or more results destination documents 110 (e.g., web pages). The information 108 is segmented and grouped into logical collections (e.g., LOGICAL COLLECTION₁, LOGICAL COLLECTION₂) of related results according to corresponding contextual templates (e.g., TEMPLATE₁, TEMPLATE₂). Each template (e.g., a template 112) is associated with an interactive label (e.g., a label 114) that exposes a corresponding collection (e.g., a collection 116) in response to label interaction (e.g., mouse over or hover).

The labels (e.g., label 114) are annotated with contextual metadata descriptive of the corresponding collection (e.g., collection 116). The labels and corresponding templates are ranked and presented for user interaction. The labels (e.g., the label 114 and a label 118) and corresponding templates (e.g., template 112 and a template 120) are ranked (in the information 108) based on scenario importance and task importance. For example, for a restaurant related site, direction information may be considered more important than review information and reservation information.

The template 112 can be a task oriented template that accepts and sends user input to a results destination document 120 via a dynamically created link. In other words, if a template is task oriented such as for a hotel reservation, then user input can be submitted from the preview to the destination page (results destination document) by a dynamically created URL (uniform resource locator).

The logical collection (e.g., collection 116) of a label (e.g., label 114) is exposed in response to a hover interaction. Other interactions can include selection of the label, for example. The logical collections (e.g., LOGICAL COLLECTION₁, LOGICAL COLLECTION₂) can be grouped based on contextual relationships. For example, an individual review score can be grouped and presented with author name, review snippet, upload date, actor's image with birth date, and biography.

The data component 102 computes available space for presentation of labels and associated templates of a given result entry. The data component 102 computes available space for presentation of labels based on a number of lines a result entry occupies. The collection of results of a template can be previewed without navigating to a corresponding results destination document.

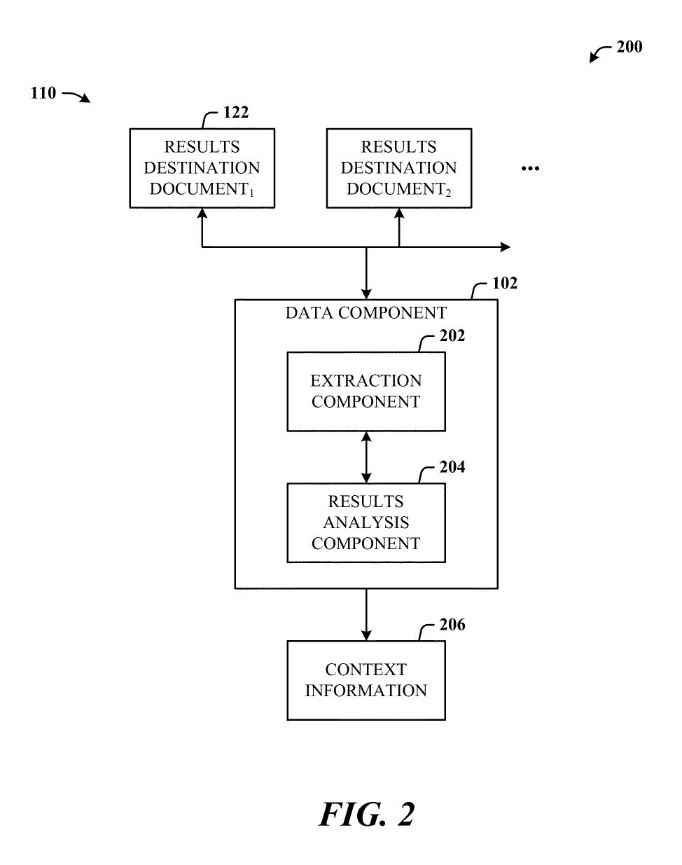

FIG. 2 illustrates a more detailed description of the data component 102. The data component 102 can include the capabilities to extract the results data from the results destination documents 110 and then analyze the results data for context. Accordingly, an extraction component 202 is provided that extracts the results data based on the user query. The term “query” is intended to include a search query for a query-search results system, as well as a question-type query for a question-answer type system. A results analysis component 204 receives the extracted data from the extraction component 202 and analyzes the data for context. Based on the derived context, the appropriate template(s) can be selected and supplemented to a result entry for ranking and preview.

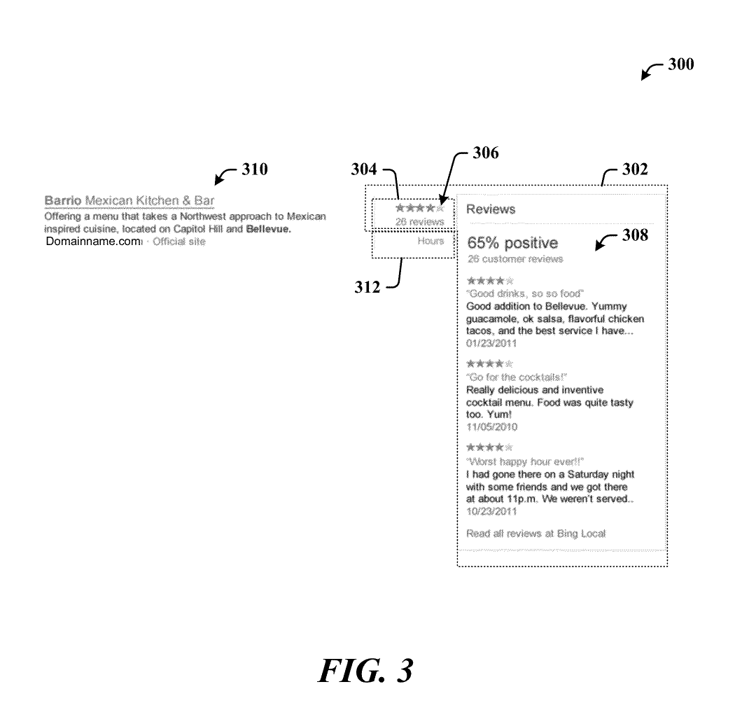

FIG. 3 illustrates a results page 300 having exemplary result entry template 302. The template 302 includes an associated label 304 annotated with contextual metadata 306 (“26 reviews” and a stars gradient bar★★★★ [symbol] ) that is descriptive of the corresponding collection 308. Here, the template 302 is positioned to the right of a results entry 310; however, this is not to be construed as limiting in that it can be located proximate the result entry 310 in other ways. The exposed template 302 is a review template that lists a collection 308 of reviews posted about the restaurant in the result entry 310. The review template 302 has the label 304 annotated with review metadata (“26 reviews” and a stars gradient bar★★★★ [symbol] ). Additionally, a hidden Hours template is associated with a label 312 annotated with Hours context information.

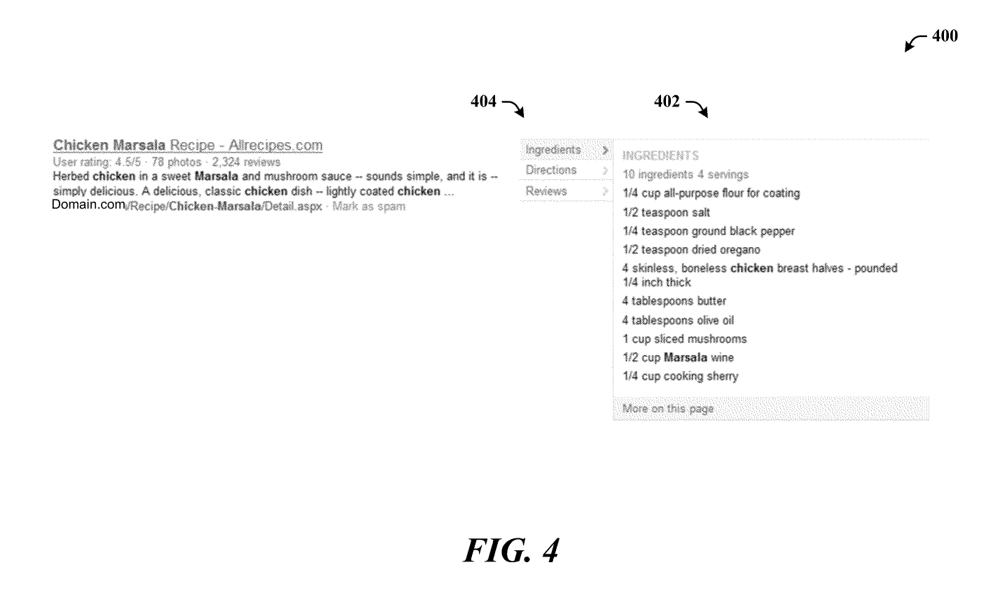

FIG. 4 illustrates a results page 400 having an exemplary ingredients type of template 402. This particular ingredients template 402 includes three labels 404 (Ingredient, Directions, Reviews) the corresponding exposed Ingredients template and two hidden Directions and Reviews templates. The labels (and hence corresponding templates) are ranked according to the task of the user, in this case, the desire to find a recipe. Had the user intent been determined to find the location of the business that provides the recipe, the Directions label is then ranked on top with the associated direction template in preview, and the ingredients and reviews templates hidden.

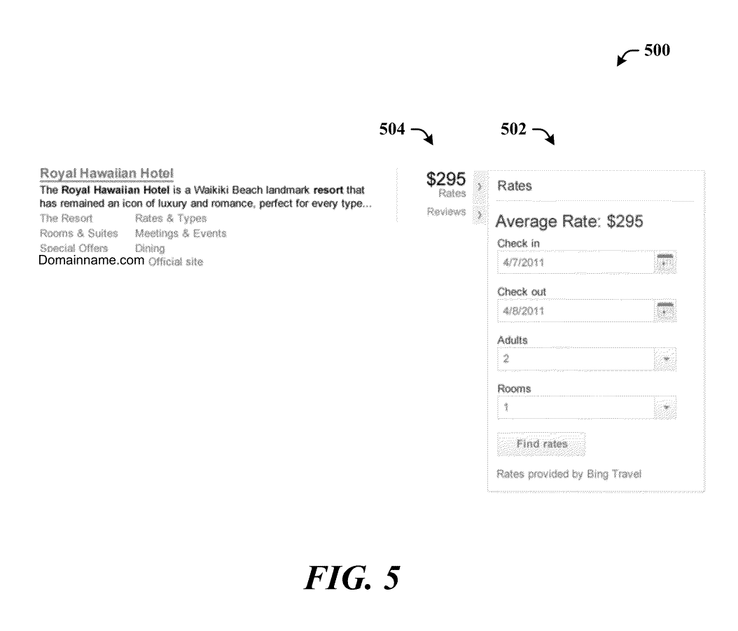

FIG. 5 illustrates a results page 500 having an exemplary hotel reservation type of template 502. This particular template 502 includes two labels 504 (Rates and Reviews) and a corresponding hidden Reviews template. The labels (and hence corresponding templates) are ranked according to the task of the user, in this case, the desire to find a hotel. The Rates label is further annotated with rate data for quick viewing by the user. The rates template 502 exposes an input form for the entry of user data (e.g., dates, number of customers, rooms, etc.) that is sent to the associated results destination document (webpage), without having to navigate to the webpage. The Review template is hidden from view since the user has interacted with the Rates label to trigger exposing of the rate template.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

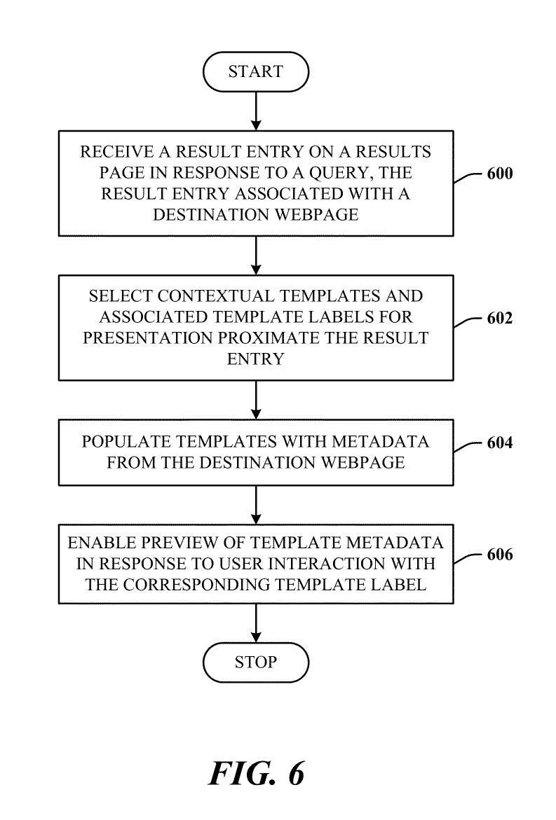

FIG. 6 illustrates a method in accordance with the disclosed architecture. At 600, a result entry is received on a results page in response to a query. The result entry is associated with a destination webpage. At 602, contextual templates and associated template labels are selected for presentation proximate the result entry. At 604, the templates are populated with metadata from the destination webpage. At 606, preview of template metadata is enabled in response to user interaction with the corresponding template label.

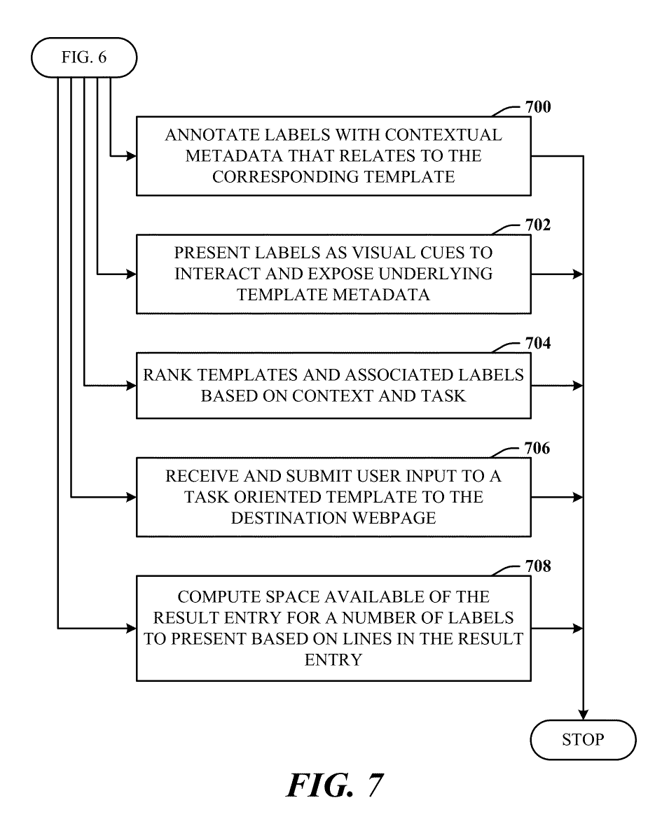

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, the labels are annotated with contextual metadata that relates to the corresponding template. At 702, the labels are presented as visual cues to interact and expose underlying template metadata. At 704, the templates and associated labels are ranked based on context and task. At 706, user input to a task oriented template is received and submitted to the destination webpage. At 708, space available of the result entry is computed for a number of labels to present based on lines in the result entry.

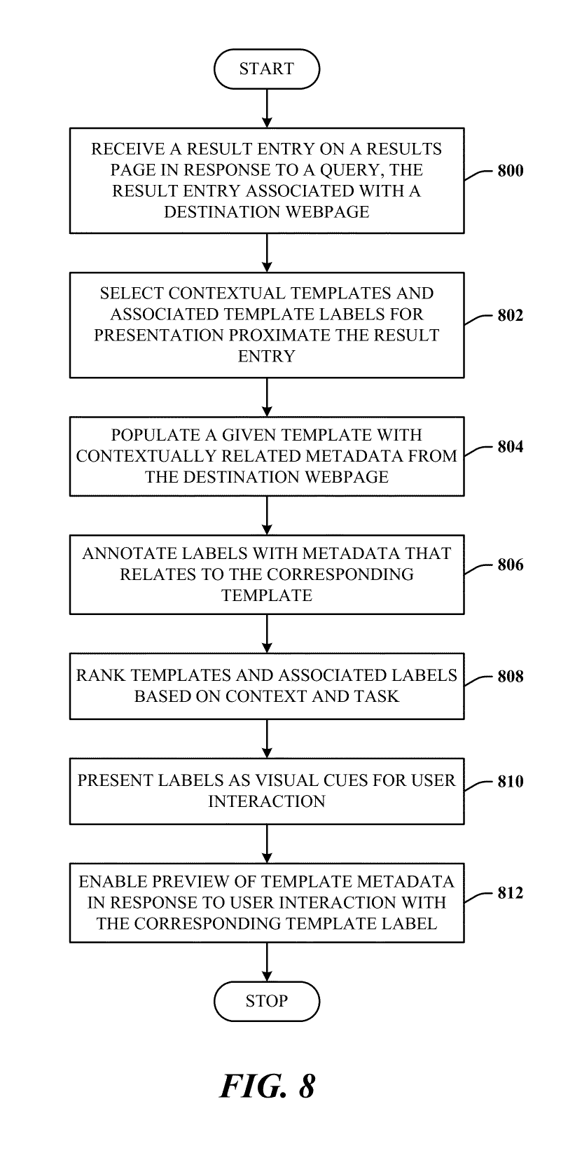

FIG. 8 illustrates an alternative method in accordance with the disclosed architecture. At 800, a result entry is received on a results page in response to a query, the result entry associated with a destination webpage. At 802, contextual templates and associated template labels are selected for presentation proximate the result entry. At 804, a given template is populated with contextually related metadata from the destination webpage. At 806, the labels are annotated with metadata that relates to the corresponding template. At 808, the templates and associated labels are ranked based on context and task. At 810, the labels are presented as visual cues for user interaction. At 812, preview of template metadata is enabled in response to user interaction with the corresponding template label.

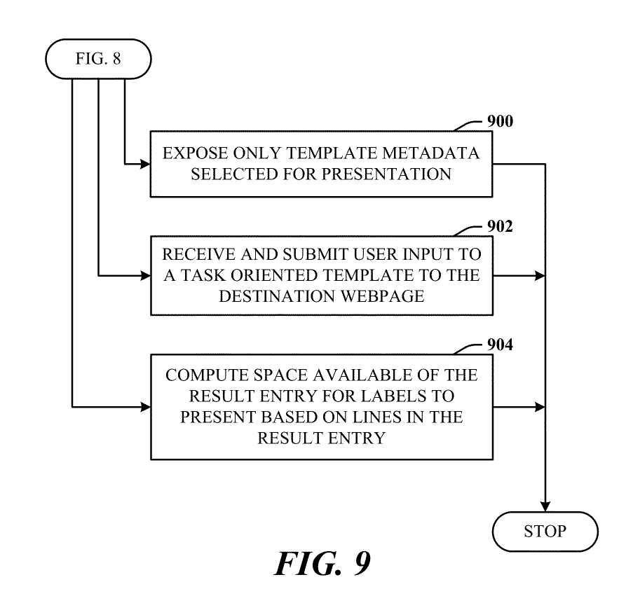

FIG. 9 illustrates further aspects of the method of FIG. 8. Note that the flow indicates that each block can represent a step that can be included, separately or in combination with other blocks, as additional aspects of the method represented by the flow chart of FIG. 8. At 900, only template metadata selected for presentation is exposed. At 902, user input is received and submitted to a task oriented template to the destination webpage. At 904, space available of the result entry is computed for labels to present based on lines in the result entry.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

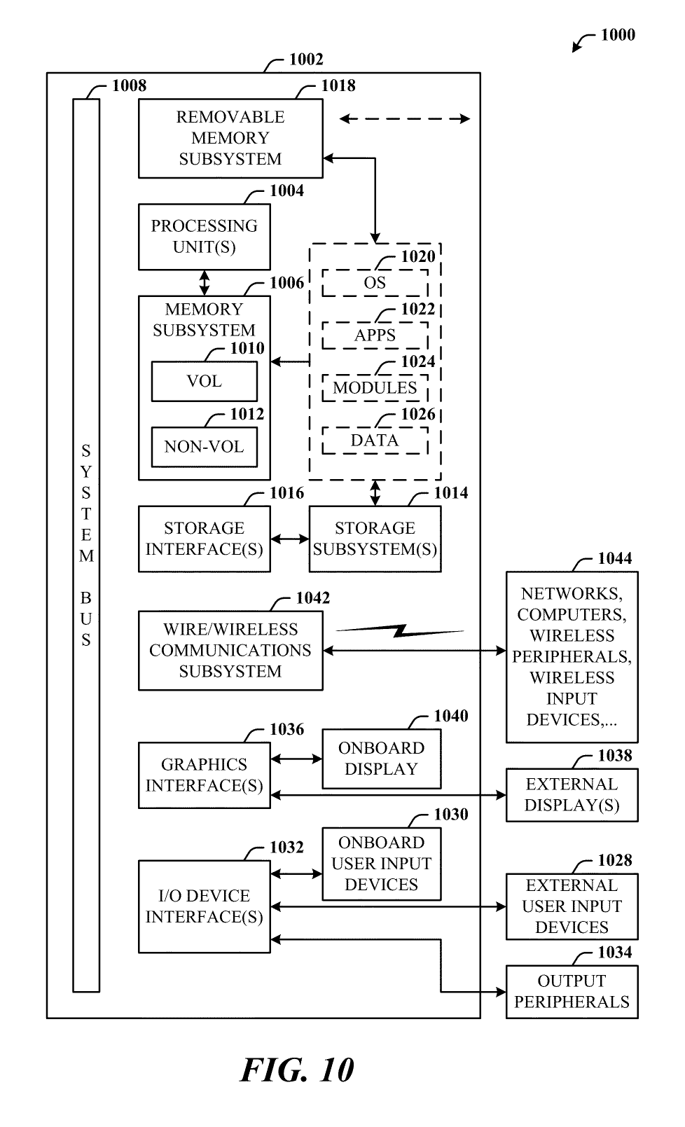

Referring now to FIG. 10, there is illustrated a block diagram of a computing system 1000 that executes segmentation, collection, and previewing in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a computer-readable storage such as a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include computer-readable storage (physical storage media) such as a volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components. The storage subsystem(s) 1014 (physical storage media) can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The operating system 1020, one or more application programs 1022, other program modules 1024, and/or program data 1026 can include entities and components of the system 100 of FIG. 1, entities and components of the data component 102 of FIG. 2, the template 302 of FIG. 3, template type 402 of FIG. 4, the template type 502 of FIG. 5, and the methods represented by the flowcharts of FIGS. 6-9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1002 and includes volatile and non-volatile internal and/or external media that is removable or non-removable. For the computer 1002, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a data component that supplements a result entry with information from a results destination document, the information is segmented and grouped into logical collections of related results according to contextual templates, each template associated with an interactive label that exposes a corresponding collection in response to label interaction; and
a processor that executes computer-executable instructions associated with the data component.

2. The system of claim 1, wherein the labels are annotated with contextual metadata descriptive of the corresponding collection.

3. The system of claim 1, wherein the labels and corresponding templates are ranked and presented for user interaction.

4. The system of claim 1, wherein the labels and corresponding templates are ranked based on scenario importance and task importance.

5. The system of claim 1, wherein the template is a task oriented template that accepts and sends user input to a results destination document via a dynamically created link.

6. The system of claim 1, wherein the logical collection of a label is exposed in response to a hover interaction.

7. The system of claim 1, wherein the logical collections are grouped based on contextual relationships.

8. The system of claim 1, wherein the data component computes available space for presentation of labels and associated templates of a given result entry.

9. The system of claim 1, wherein the data component computes available space for presentation of labels based on a number of lines a result entry occupies.

10. The system of claim 1, wherein the collection of results of a template is previewed without navigating to a corresponding results destination document.

11. A method, comprising acts of:
receiving a result entry on a results page in response to a query, the result entry associated with a destination webpage;
selecting contextual templates and associated template labels for presentation proximate the result entry;
populating the templates with metadata from the destination webpage;
enabling preview of template metadata in response to user interaction with the corresponding template label; and
utilizing a processor that executes instructions stored in memory to perform at least one of the acts of receiving, selecting, populating, or enabling.

12. The method of claim 11, further comprising annotating the labels with contextual metadata that relates to the corresponding template.

13. The method of claim 11, further comprising presenting the labels as visual cues to interact and expose underlying template metadata.

14. The method of claim 11, further comprising ranking the templates and associated labels based on context and task.

15. The method of claim 11, further comprising receiving and submitting user input to a task oriented template to the destination webpage.

16. The method of claim 11, further comprising computing space available of the result entry for a number of labels to present based on lines in the result entry.

17. A method, comprising acts of:
receiving a result entry on a results page in response to a query, the result entry associated with a destination webpage;
selecting contextual templates and associated template labels for presentation proximate the result entry;
populating a given template with contextually related metadata from the destination webpage;
annotating the labels with metadata that relates to the corresponding template;
ranking the templates and associated labels based on context and task;
presenting the labels as visual cues for user interaction;
enabling preview of template metadata in response to user interaction with the corresponding template label; and
utilizing a processor that executes instructions stored in memory to perform at least one of the acts of receiving, selecting, populating, annotating, ranking, presenting, or enabling.

18. The method of claim 17, further comprising exposing only template metadata selected for presentation.

19. The method of claim 17, further comprising receiving and submitting user input to a task oriented template to the destination webpage.

20. The method of claim 17, further comprising computing space available of the result entry for labels to present based on lines in the result entry.
